(19) United States
(12) Patent Application Publication
(10) Pub. No.: US 2025/0059363 A1
(43) Pub. Date: Feb. 20, 2025

(54) RESIN COMPOSITION AND PURGING AGENT USING SAME, AND MOLDING MACHINE PURGING METHOD

(71) Applicant: Kuraray Co., Ltd., Okayama (JP)

(72) Inventor: Makoto SUZUKI, Chiyoda-ku, Tokyo (JP)

(73) Assignee: Kuraray Co., Ltd., Okayama (JP)

(21) Appl. No.: 18/722,172

(22) PCT Filed: Dec. 14, 2022
(86) PCT No.: PCT/JP2022/046107

§ 371 Date: Jun. 20, 2024

(30) Foreign Application Priority Data
Dec. 21, 2021 (JP) 2021-206940

(51) Int. Cl. C08L 29/04; B29C 48/27; C08K 3/105

(52) U.S. Cl. CPC C08L 29/04; B29C 48/27; C08K 3/105

(57) ABSTRACT

The present disclosure provides a resin composition containing a hydrophilic resin (A), water (B), a basic compound (C), and a polyolefin resin (D).

### TECHNICAL FIELD

The present invention relates to a resin composition, a purging agent using the same, and a molding machine purging method, and more particularly to a resin composition with improved handleability and safety, a purging agent using the same, and a molding machine purging method.

### BACKGROUND ART

Resins with high gas barrier properties, including ethylene-vinyl alcohol copolymers (also referred to as “EVOHs” hereinafter), are widely used in products such as films and containers for food packaging. When a resin to be processed is melt-extruded in a molding machine in order to obtain such a product, adhesion of the resin may occur in flow passages of the molding machine (for example, the resin may adhere to a screw). If this adhering resin is left as it is for a long period of time, the resin undergoes deterioration such as scorching, gelation, and decomposition. This causes resulting products to have defects such as streaks, hard spots, and gels, or requires an enormous amount of time and incurs a material loss in order to eliminate such defects.

Various purging agents have been proposed. For example, Patent Document 1 discloses a purging agent containing a hydrophobic thermoplastic resin such as a polyolefin resin, a hydrophilic thermoplastic resin such as a saponified ethylene-vinyl acetate copolymer, and water. Patent Document 2 discloses a purging agent prepared by blending a saponified ethylene-vinyl ester copolymer or the like and water in a predetermined ratio. Patent Document 3 discloses a purging agent containing a polyolefin resin such as low-density polyethylene (LDPE), a strongly basic compound such as an alkali metal or alkaline earth metal hydroxide, and a salt that generates free water. Patent Document 4 discloses that a resin composition containing a hydrophilic resin, water, and a basic compound in a predetermined ratio can be used as a purging agent.

### RELATED ART DOCUMENTS

### Patent Documents

Patent Document 1: JPH10-016023A
Patent Document 2: JP2008-279623A
Patent Document 3: JP2012-533647A
Patent Document 4: WO2021/019873A1

### SUMMARY OF INVENTION

### Problem to be Solved by the Invention

However, it cannot be said that the purging agents disclosed in Patent Document 1 and Patent Document 2 are able to sufficiently remove a resin (hereinafter also referred to as a “resin to be purged”) adhering to a screw and the like of a molding machine, and an improvement in purging ability is desired. On the other hand, the purging agent disclosed in Patent Document 3 has improved purging ability due to one of its components, the basic compound, but the purging ability is not satisfactory. As for the purging agent disclosed in Patent Document 4, further improvement is desired in terms of the purging ability to purge resins with a wider range of viscosities (for example, low viscosities).

The present invention was made to solve the above-described problems, and it is an object thereof to provide a purging agent capable of efficiently discharging a resin to be purged, for example, a low-viscosity resin to be purged, in a molding machine, and a molding machine purging method using the purging agent.

### Means for Solving the Problem

According to the present invention, the above-mentioned object can be achieved by providing:
[1] a resin composition comprising a hydrophilic resin (A), water (B), a basic compound (C), and a polyolefin resin (D),
wherein the content of the water (B) is 10 to 70 parts by mass with respect to 100 parts by mass of the hydrophilic resin (A),
the content of the basic compound (C) is 0.1 to 15 parts by mass with respect to 100 parts by mass of the hydrophilic resin (A), and
the polyolefin resin (D) satisfies the formula (1) below:

$$30 > X \times Y \div ( 1 - Z ) \geq 1 \qquad ( 1 )$$

where, in the formula (1), X represents MFR (g/10 min) of the polyolefin resin (D) at 190° C., Y represents relaxation time (seconds) of the polyolefin resin (D) at 220° C., and Z represents density (g/cm³) of the polyolefin resin (D);
[2] the resin composition according to [1], wherein the hydrophilic resin (A), the water (B), and the basic compound (C) are contained together in the form of a water-containing hydrophilic resin;
[3] the resin composition according to [2], wherein the water-containing hydrophilic resin is in porous particle form and has a median pore diameter of 0.01 to 3 μm and an average particle size of 2.5 to 8 mm;
[4] the resin composition according to any one of [1] to [3], wherein the content of the polyolefin resin (D) is 100 to 5000 parts by mass with respect to 100 parts by mass of the hydrophilic resin (A);
[5] the resin composition according to any one of [1] to [4], wherein the hydrophilic resin (A) is an ethylene-vinyl alcohol copolymer;
[6] the resin composition according to [5], wherein the ethylene-vinyl alcohol copolymer has an ethylene unit content of 15 to 60 mol %;
[7] the resin composition according to any one of [1] to [6], wherein the basic compound (C) is at least one selected from alkali metal carbonates, alkali metal bicarbonates, alkali metal phosphates, alkali metal acetates, alkali metal hydroxides, ammonia, and primary to tertiary amines;
[8] the resin composition according to any one of [1] to [6], wherein the polyolefin resin (D) is at least one resin selected from the group consisting of polyethylene and polypropylene;
[9] the resin composition according to any one of [1] to [8], further comprising at least one element selected from the group consisting of silicon and phosphorus in a proportion of 10 to 1000 ppm.
[10] the resin composition according to any one of [1] to [9], further comprising a divalent metal element in a proportion of 100 ppm or less;
[11] the resin composition according to any one of [1] to [10], wherein the divalent metal element is at least one element selected from the group consisting of calcium and magnesium;
[12] the resin composition according to anyone of [1] to [11], which is in pellet form;
[13] a purging agent comprising the resin composition according to any one of [1] to [12];
[14] the purging agent according to [13], which is used for purging of a molding machine that uses a molding resin composition having a MFR (g/10 min) higher than half the value of that of the polyolefin resin (D) at 190° C. or melt fluidity higher than half the melt fluidity of the polyolefin resin (D);
[15] the purging agent according to [14], which is used for purging of a food packaging material molding machine;
[16] a method for purging a molding machine in which a resin to be purged is present, comprising a step of supplying the purging agent according to any one of [13] to [15] into the molding machine and discharging the purging agent together with the resin to be purged.

### Effects of the Invention

According to the present invention, a resin to be purged in a molding machine can be efficiently discharged from the molding machine. Thus, defects in products obtained using the molding machine can be reduced.

### DESCRIPTION OF EMBODIMENTS

### Resin Composition

A resin composition of the present invention is a resin composition that can be used as a purging agent, for example, for purging a molding machine in which a resin to be purged, which will be described later, is present.

The resin composition of the present invention contains a hydrophilic resin (A), water (B), a basic compound (C), and a polyolefin resin (D).

### Hydrophilic Resin (A)

The hydrophilic resin (A) encompasses resins that have an affinity for water, and examples thereof include resins having a contact angle with water of 0° to 90°. As such, the hydrophilic resin (A) is, for example, preferably at least one selected from the group consisting of an EVOH, a polyvinyl alcohol, a polyamide, a polyacrylate, a polyethylene glycol, and a polyacrylamide. In particular, an EVOH is more preferable in terms of thermal stability and extrusion stability. When the hydrophilic resin (A) is used, an aqueous alkaline solution containing water (B) and the basic compound (C) is stably held in the hydrophilic resin (A) during storage of a purging agent composed of the resin composition of the present invention at normal temperature, and thus, the safety of a user can be ensured. In addition, during purging, the hydrophilic resin (A) melts and thereby releases the aqueous alkaline solution, and thus, the resin to be purged adhering to a screw can be effectively decomposed and removed.

### EVOH

The EVOH is a copolymer obtained, for example, by saponifying an ethylene-vinyl ester copolymer. The ethylene-vinyl ester copolymer can be produced and saponified using known methods. Examples of the vinyl ester that can be used in such a method include fatty acid vinyl esters such as vinyl acetate, vinyl formate, vinyl propionate, vinyl pivalate, and vinyl versatate.

In the present invention, the ethylene unit content in the EVOH is preferably 15 mol % or more, 22 mol % or more, or 24 mol % or more, for example. In the present invention, the ethylene unit content in the EVOH is preferably 60 mol % or less, 55 mol % or less, or 50 mol % or less, for example. If the ethylene unit content is less than 15 mol %, extrusion of the resin composition may be difficult when the temperature of a melting zone of the molding machine is 105° C. to 210° C. If the ethylene unit content is more than 60 mol %, the amount of hydroxy groups decreases, and it tends to be difficult to secure a desired water content. The ethylene unit content in the EVOH can be measured using, for example, a nuclear magnetic resonance (NMR) technique.

In the present invention, the saponification degree of the EVOH (i.e., the saponification degree of the vinyl ester component in the EVOH) is, for example, preferably 99 mol % or more, more preferably 99.5% or more, and even more preferably 99.9 mol % or more. When the saponification degree is 99 mol % or more, for example, it is possible to prevent the basic compound (C) from being consumed during a saponification reaction. On the other hand, the saponification degree of the EVOH is, for example, preferably 100 mol % or less, and may be 99.99 mol % or less. The saponification degree of the EVOH can be calculated by measuring the peak area of hydrogen atoms contained in the vinyl ester structure and the peak area of hydrogen atoms contained in the vinyl alcohol structure through ¹H-NMR measurement.

The EVOH may also include a unit derived from an additional monomer other than ethylene, vinyl ester, and saponified products thereof to the extent that the object of the present invention is not inhibited. When the EVOH includes an additional monomer unit, the upper limit of the additional monomer unit content in all the structural units of the EVOH is, for example, 30 mol % or less, 20 mol % or less, 10 mol % or less, or 5 mol % or less. When the EVOH includes the unit derived from the additional monomer, the content thereof is, for example, preferably 0.05 mol % or more, and more preferably 0.1 mol % or more.

Examples of the additional monomer include alkenes such as propylene, butylene, pentene, and hexene; ester group-containing alkenes such as 3-acyloxy-1-propene, 3-acyloxy-1-butene, 4-acyloxy-1-butene, 3,4-diacyloxy-1-butene, 3-acyloxy-4-methyl-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene, and 1,3-diacetoxy-2-methylenepropane, or saponified products thereof, unsaturated acids such as acrylic acid, methacrylic acid, crotonic acid, and itaconic acid, or anhydrides, salts, monoalkyl esters, or dialkyl esters thereof, nitriles such as acrylonitrile and methacrylonitrile; amides such as acrylamide and methacrylamide; olefin sulfonic acids such as vinyl sulfonic acid, allyl sulfonic acid, and methallyl sulfonic acid, or salts thereof, vinylsilane compounds such as vinyltrimethoxysilane, vinyltriethoxysilane, vinyltri(β-methoxy-ethoxy)silane, and γ-methacryloxypropylmethoxysilane; alkyl vinyl ethers, vinyl ketones, N-vinylpyrrolidone, vinyl chloride, and vinylidene chloride.

The EVOH may be modified through urethanation, acetalation, cyanoethylation, oxyalkylenation, or the like. When used in a purging agent, the modified EVOH improves compatibility with a resin to be purged made of, for example, a urethane resin, an acetal resin, or an acrylonitrile resin and therefore enables more efficient purging.

A combination of two or more EVOHs that differ in the ethylene unit content, the saponification degree, the copolymer component, whether or not they are modified, the modification type, or the like may also be used as the EVOH.

The EVOH can be obtained using a known technique such as bulk polymerization, solution polymerization, suspension polymerization, or emulsion polymerization. In an embodiment, bulk polymerization or solution polymerization in which polymerization can progress without solvent or in a solution of alcohol or the like is used.

There is no particular limitation on the solvent used in solution polymerization, and examples thereof include alcohols, preferably lower alcohols such as methanol, ethanol, and propanol. The amount of solvent used in the polymerization reaction solution can be selected in consideration of the target viscosity-average polymerization degree of the EVOH and the chain transfer of the solvent, and the ratio (solvent/total monomers) of the mass of the solvent contained in the reaction solution to the total mass of monomers contained therein is, for example, 0.01 to 10, and preferably 0.05 to 3.

Examples of a catalyst used in the above-mentioned polymerization include azo-based initiators such as 2,2-azobisisobutyronitrile, 2,2-azobis-(2,4-dimethylvaleronitrile), 2,2-azobis-(4-methoxy-2,4-dimethylvaleronitrile), and 2,2-azobis-(2-cyclopropylpropionitrile); and organic peroxide-based initiators such as isobutyryl peroxide, cumyl peroxyneodecanoate, diisopropyl peroxycarbonate, di-n-propyl peroxydicarbonate, t-butyl peroxyneodecanoate, lauroyl peroxide, benzoyl peroxide, and t-butyl hydroperoxide.

The polymerization temperature is preferably 20° C. to 90° C., and more preferably 40° C. to 70° C. The polymerization time is preferably 2 hours to 15 hours, and more preferably 3 hours to 11 hours. The polymerization rate is preferably 10% to 90%, and more preferably 30% to 80%, with respect to vinyl ester prepared for the polymerization. The resin content in the solution after the polymerization is preferably 5% to 85%, and more preferably 20% to 70%.

In the above-mentioned polymerization, after polymerization has been performed for a predetermined period of time, or a predetermined polymerization rate has been reached, a polymerization inhibitor is added as necessary, unreacted ethylene gas is removed through evaporation, and unreacted vinyl ester is removed. Thus, the EVOH can be obtained.

Then, the copolymer is saponified by adding an alkaline catalyst to the copolymer solution. The saponification method may be either a continuous method or a batch method, for example. Examples of the alkaline catalyst that can be added include sodium hydroxide, potassium hydroxide, and alkali metal alcoholates.

The EVOH after the saponification reaction contains the alkaline catalyst, by-product salts such as sodium acetate and potassium acetate, and other impurities. Therefore, it is preferable to remove them as necessary through neutralization or washing. Here, when the EVOH after the saponification reaction is washed with water (e.g., ion-exchanged water) that is substantially free of predetermined ions (e.g., metal ions and chloride ions), by-product salts such as sodium acetate and potassium acetate need not be entirely removed, and a portion thereof may remain.

The EVOH may contain an acid, a boron compound, a plasticizer, a filler, an antiblocking agent, a lubricant, a stabilizer, a surfactant, a colorant, an ultraviolet absorber, an antistatic agent, a drying agent, a cross-liking agent, a reinforcement such as various fibers, and other components.

The above-mentioned acid is preferably a carboxylic acid compound, a phosphoric acid compound, or the like in view of their ability to enhance thermal stability of the EVOH during melt molding. When the EVOH contains a carboxylic acid compound, the carboxylic acid content (i.e., the carboxylic acid content in the resin composition containing the EVOH) is preferably 1 ppm or more, more preferably 10 ppm or more, and even more preferably 50 ppm or more. On the other hand, the carboxylic acid compound content is preferably 10000 ppm or less, more preferably 1000 ppm or less, and even more preferably 500 ppm or less. When the EVOH contains a phosphoric acid compound, the phosphoric acid content (i.e., the phosphoric acid compound content, in terms of phosphate radical, in the resin composition containing the EVOH) is preferably 1 ppm or more, more preferably 10 ppm or more, and even more preferably 30 ppm or more. On the other hand, the phosphoric acid compound content is preferably 10000 ppm or less, more preferably 1000 ppm or less, and even more preferably 300 ppm or less. When the carboxylic acid compound content or the phosphoric acid compound content is in the range described above, the EVOH exhibits good thermal stability during purging.

When the EVOH contains the above-mentioned boron compound, the content thereof (i.e., the boron compound content, in terms of boron, in the resin composition containing the EVOH) is preferably 1 ppm or more, more preferably 10 ppm or more, and even more preferably 50 ppm or more. On the other hand, the boron compound content is preferably 2000 ppm or less, more preferably 1000 ppm or less, and even more preferably 500 ppm or less. When the boron compound content is in the range described above, the EVOH tends to exhibit good thermal stability during purging.

There is no particular limitation on the method for causing the carboxylic acid compound, the phosphoric acid compound, or the boron compound to be contained in the resin composition containing the EVOH, and, for example, the compound may be added and kneaded in the composition containing the EVOH during pelletization of the composition. In addition, a method in which the compound is added as a dry powder, a method in which the compound is added as a paste obtained by impregnating the compound with a predetermined solvent, a method in which the compound is added in a state of being suspended in a predetermined liquid, a method in which the compound is added as a solution in which the compound is dissolved in a predetermined solvent, a method in which the compound is immersed in a predetermined solution, and the like may also be used. Of these methods, the method in which the compound is added as a solution in which the compound is dissolved in a predetermined solvent and the method in which the compound is immersed in a predetermined solution are preferable, because those two methods enable homogeneous dispersion of the compound in the EVOH. The predetermined solvent is not particularly limited, but is preferably water in view of the solubility of the compound to be added, cost, ease of handling, safety of the working environment, and the like.

### Polyvinyl Alcohol

The polyvinyl alcohol is a resin obtained by saponifying a polymer of vinyl ester monomers. Examples of the vinyl ester monomers include vinyl formate, vinyl acetate, vinyl propionate, vinyl valerate, vinyl caprate, vinyl laurate, vinyl stearate, 2,2,4,4-tetramethyl vinyl valerate, vinyl benzoate, vinyl pivalate, vinyl versatate, and the like. Of these, vinyl acetate, vinyl propionate, vinyl pivalate, and vinyl versatate are preferably used alone or as a mixture.

The saponification degree of the polyvinyl alcohol is not particularly limited, but is preferably 80 mol % or more, more preferably 90 mol % or more, and even more preferably 95 mol % or more.

### Polyamide

The polyamide is a polymer having an amide bond in its main chain. Examples of the polyamide include polycaproamide (nylon 6), poly-ω-aminoheptanoic acid (nylon 7), poly-ω-aminononanoic acid (nylon 9), polyundecanamide (nylon 11), polylauryllactam (nylon 12), polyethylene diamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 106), a caprolactam/lauryllactam copolymer (nylon 6/12), a caprolactam/ω-aminononanoic acid copolymer (nylon 6/9), a caprolactam/hexamethylene diammonium adipate copolymer (nylon 6/66), a lauryllactam/hexamethylene diammonium adipate copolymer (nylon 12/66), an ethylene diammonium adipate/hexamethylene diammonium adipate copolymer (nylon 26/66), a caprolactam/hexamethylene diammonium adipate/hexamethylene diammonium sebacate copolymer (nylon 6/66/610), an ethylene diammonium adipate/hexamethylene diammonium adipate/hexamethylene diammonium sebacate copolymer (nylon 26/66/610), polyhexamethylene isophthalamide (nylon 6T), polyhexamethylene terephthalamide (nylon 6T), a hexamethylene isophthalamide/hexamethylene terephthalamide copolymer (nylon 6I/6T), a 11-aminoundecanamide/hexamethylene terephthalamide copolymer, polynonamethylene terephthalamide (nylon 9T), polydecamethylene terephthalamide (nylon 10T), polyhexamethylene cyclohexylamide, and polynonamethylene cyclohexylamide, as well as those that are obtained by modifying these polyamides with aromatic amines such as methylenebenzylamine and metaxylene diamine. Other examples include m-xylylene diammonium adipate and the like.

The polyamide can be obtained using a method such as melt polymerization, interfacial polymerization, solution polymerization, bulk polymerization, solid phase polymerization, or a combination of these methods.

### Polyacrylate

The polyacrylate can be produced through, for example, polymerization of acrylate monomers, such as methyl acrylate, ethyl acrylate, n-propyl acrylate, isopropyl acrylate, n-butyl acrylate, isobutyl acrylate, pentyl acrylate, 2-ethylhexyl acrylate, decyl acrylate, dodecyl acrylate, stearyl acrylate, α-chloroethyl acrylate, cyclohexyl acrylate, phenyl acrylate, methoxyethyl acrylate, ethoxyethyl acrylate, methoxypropyl acrylate, or ethoxypropyl acrylate, followed by hydrolysis, or can also be obtained by polymerizing acrylonitrile and hydrolyzing the resulting polymer.

Examples of the salt that constitutes the polyacrylate include alkali metal salts such as sodium, potassium, and lithium salts, alkaline earth metal salts such as calcium, magnesium, and barium salts, as well as ammonium salts such as quaternary ammonium and quaternary alkylammonium salts. In particular, sodium salts are most commonly used and are preferable.

### Polyethylene Glycol

The polyethylene glycol is produced by addition polymerization in which ethylene oxide is added to a compound having two or more active hydrogen atoms, such as ethylene glycol or diethylene glycol.

When adding ethylene oxide, an alkali metal compound may be used as a catalyst. The alkali metal compound may be a hydroxide of an alkali metal (e.g., lithium, sodium, potassium, or the like), an alkali metal alcoholate (e.g., sodium methylate or potassium methylate), or the like. In particular, sodium hydroxide and potassium hydroxide are preferable in terms of reactivity. One alkali metal compound may be used alone, or two or more alkali metal compounds may be used in combination.

### Polyacrylamide

As the polyacrylamide, a polyacrylamide that is a homopolymer of acrylamide or a copolymer of acrylamide and another copolymerizable monomer and that has an amide bond is used.

There is no particular limitation on the method for producing the polyacrylamide, and (i) a method in which acrylamide or acrylamide and the other copolymerizable monomer are polymerized in methanol using 2,2′-azobisisobutyronitrile as an initiator, (ii) a method in which acrylamide or acrylamide and the other copolymerizable monomer are irradiated with light in ethanol, (iii) a method in which redox polymerization of acrylamide or acrylamide and the other copolymerizable monomer is performed in an aqueous solution, (vi) a method in which acrylamide or acrylamide and the other copolymerizable monomer, in solid form, are irradiated with γ-rays, and the like can be used.

Examples of the other monomer copolymerizable with acrylamide include acrylic acid, methacrylic acid, styrenesulfonic acid, ethylenesulfonic acid, 2-acrylamide-2-methylpropanesulfonic acid, a methacrylic acid dimethylaminoethyl ester, dimethylaminopropyl methacrylate, dimethylaminoethyl acrylate, dimethylaminopropyl acrylate, diallyldimethylammonium chloride and its quaternary salt and the like, C₁-C₂₄ alkyl esters of acrylic acid, such as methyl (meth)acrylate, ethyl (meth)acrylate, and butyl (meth)acrylate, and the like.

### Water (B)

Water (B) dissolves the basic compound (C), which will be described later, to prepare an aqueous solution having a desired pH, and also diffuses the above-mentioned EVOH widely in the molding machine to promote the discharge of the resin to be purged that is present in the machine.

Water (B) that constitutes the resin composition of the present invention may be, for example, pure water, ion-exchanged water, distilled water, tap water, or a combination thereof. Ion-exchanged water is preferable because it prevents unintentional salt contamination.

The content of water (B) in the resin composition of the present invention is 10 parts by mass or more, preferably 15 parts by mass or more, and more preferably 20 parts by mass or more, with respect to 100 parts by mass of the hydrophilic resin (A). Also, the content of water (B) is 70 parts by mass or less, preferably 50 parts by mass or less, and more preferably 30 parts by mass or less, with respect to 100 parts by mass of the hydrophilic resin (A). When the mass ratio between the hydrophilic resin (A) and the water (B) is in the range described above, uneven distribution of water on the surface of a purging agent composed of the resin composition of the present invention can be suppressed. Thus, the resin composition of the present invention can be prevented from adhering to a hopper when being loaded into the molding machine as a purging agent, and scattering of the aqueous solution containing the basic compound (C) from the purging agent can be prevented. For these reasons, it is preferable for safety that the mass ratio is in the range described above. The hydrophilic resin (A) in the resin composition of the present invention has a high affinity for water (B) and moderately binds to water via a hydrogen bond, and therefore, during purging, water necessary for purging can be released in the molding machine, and a sufficient viscosity to discharge the resin to be purged, out of the molding machine can be ensured. Furthermore, unwanted water does not remain in the molding machine during purging, and feed defects can be reduced.

In a first embodiment of the resin composition of the present invention, water (B) is one of the important components for exerting the function of purging the resin to be purged.

On the other hand, in a second embodiment of the resin composition of the present invention, water (B) may be one of optional components. That is, although water (B) needs to be contained as a component of the resin composition passing through the molding machine when purging the resin to be purged, it need not be contained in the purging agent in advance before being supplied into the molding machine. For example, water (B) may be supplied into the molding machine separately from the purging agent when the purging agent is supplied into the molding machine, and mixed with the components constituting the purging agent in the molding machine to constitute the resin composition of the present invention.

Basic Compound (C) The basic compound (C) is turned into an aqueous solution by water (B) described above, and creates alkaline conditions (preferably, strong alkaline conditions) in the molding machine, thereby serving to promote the discharge of the resin to be purged that is present in the molding machine.

Examples of the basic compound (C) include alkali metal carbonates, alkali metal bicarbonates, alkali metal phosphates, alkali metal acetates, alkali metal hydroxides, ammonia and primary to tertiary amines, and combinations thereof.

When water (B) and the hydrophilic resin (A) are together in the form of a water-containing hydrophilic resin, examples of the basic compound (C) include alkali metal carbonates, alkali metal bicarbonates, alkali metal phosphates, alkali metal acetates, alkali metal hydroxides, ammonia and primary to tertiary amines, and combinations thereof. On the other hand, when water (B) and the basic compound (C) are together in the form of an aqueous alkaline solution, examples of the basic compound (C) include alkali metal carbonates, alkali metal bicarbonates, alkali metal phosphates, alkali metal acetates, ammonia and primary to tertiary amines, and combinations thereof.

Examples of the alkali metal carbonates include sodium carbonate, potassium carbonate, lithium carbonate, and combinations thereof. Examples of the alkali metal bicarbonates include sodium hydrogencarbonate, potassium hydrogencarbonate, and combinations thereof. Examples of the alkali metal phosphates include trisodium phosphate, disodium hydrogen phosphate, monosodium dihydrogen phosphate, tripotassium phosphate, dipotassium hydrogen phosphate, monopotassium dihydrogen phosphate, trilithium phosphate, dilithium hydrogen phosphate, monolithium dihydrogen phosphate, and combinations thereof. Examples of the alkali metal acetates include sodium acetate, potassium acetate, lithium acetate, and combinations thereof. Examples of the alkali metal hydroxides include sodium hydroxide, potassium hydroxide, lithium hydroxide, and combinations thereof. Sodium carbonate and potassium carbonate are preferable because they have sufficient purging ability and make it possible that the resulting purging agent ensures the safety of a worker.

The content of the basic compound (C) is 0.1 parts by mass or more, preferably 0.5 parts by mass or more, and even more preferably 1 part by mass or more, with respect to 100 parts by mass of the hydrophilic resin (A). Also, the content of the basic compound (C) is 15 parts by mass or less, preferably 12 parts by mass or less, and even more preferably 10 parts by mass or less, with respect to 100 parts by mass of the hydrophilic resin (A). If the content of the basic compound (C) is less than 0.1 parts by mass, the aqueous solution formed by the basic compound (C) and water (B) tends to become close to neutral, resulting in a decreased efficiency of discharging the resin to be purged in the molding machine. If the content of the basic compound (C) is more than 15 parts by mass, the aqueous alkaline solution tends to be saturated, causing salt precipitation during storage of the purging resin.

When water (B) and the basic compound (C) are together in the form of an aqueous alkaline solution, the pH of the aqueous alkaline solution and/or the resin composition of the present invention is preferably 8 to 14, and more preferably 10 to 13. If the pH is less than 8, the efficiency with which the resulting resin composition discharges the resin to be purged in the molding machine tends to be low.

### Water-Containing Hydrophilic Resin

In the resin composition of the present invention, the above-described hydrophilic resin (A), water (B), and basic compound (C) may be contained together in the form of a water-containing hydrophilic resin.

The water-containing hydrophilic resin is preferably in porous particle form because, when the resin composition of the present invention is used as a purging agent, water contained in the particles can be released in the molding machine.

Such porous particles have a large number of pores on the surface and can suitably retain water contained in the porous particles and suitably release water in the molding machine.

The median pore diameter of the porous particles is preferably 0.01 to 3 μm, and more preferably 0.05 to 2 μm. The median pore diameter of the porous particles is measured using a mercury intrusion method. If the median pore diameter is not more than 0.01 μm, the amount of water absorption is low, and the resulting resin composition may not exhibit effective purging ability when used as a purging agent. If the median pore diameter is not less than 3 μm, water cannot be retained in the porous particles because water release is too rapid, and the resulting resin composition may not exhibit effective purging ability when used as a purging agent.

The pore surface area of the porous particles is preferably 25 to 60 m²/g, and more preferably 30 to 45 m²/g. When the pore surface area of the porous particles is in the range described above, the basic compound (C) can be moderately adsorbed. The pore surface area of the porous particles is measured using a mercury intrusion method. If the pore surface area is less than 25 m²/g, the water content of the porous particles may decrease. If the pore surface area is more than 60 m²/g, the strength of the porous particles decreases, resulting in reduced handleability, and the likelihood of generation of fines and chipping of pellets occurring in the resin composition obtained as the final product may also be increased.

An example of the methods for adjusting the median pore diameter and pore surface area of the porous particles is to adjust the water content, alcohol content, and extrusion temperature of an EVOH paste when producing water-containing EVOH pellets. Note that, when obtaining water-containing EVOH pellets through precipitation of strand-shaped products, it is also possible to adjust the median pore diameter and pore surface area by adjusting the concentration of the EVOH solution, the temperature and alcohol concentration of the precipitation bath, and the washing temperature of the obtained water-containing EVOH pellets.

Furthermore, the porous particles have an average particle size of preferably 2.5 to 8 mm, and more preferably 3 to 6 mm. If the average particle size of the porous particles is less than 2.5 mm, separation of the porous particles from other resins may occur during introduction into an extruder. If the average particle size is more than 8 mm, the bite into a hopper during introduction into an extruder may be reduced.

In the present invention, examples of the method for preparing a water-containing hydrophilic resin from the above-described hydrophilic resin (A), water (B), and basic compound (C) include, but are not limited to, a method in which water (B) containing the basic compound (C) is sprayed onto the hydrophilic resin (A); a method in which the hydrophilic resin (A) is immersed in water (B) containing the basic compound (C); a method in which a mixture of the hydrophilic resin (A) and the basic compound is brought into contact with water vapor, which is a form of water (B); a method in which the hydrophilic resin (A), water (B), and the basic compound (C) are extruded together; and the like. Specifically, a method in which the hydrophilic resin (A) is autoclaved in the presence of water (B) containing the basic compound (C); a method in which the hydrophilic resin (A) is loaded into an extruder and subjected to wet extrusion while water (B) and the basic compound (C) are added in midstream; and the like may be used.

### Polyolefin Resin (D)

The polyolefin resin (D) serves, for example, to improve the compatibility between the resin composition of the present invention and the resin to be purged (e.g., low-viscosity resin to be purged) in the molding machine and the safety of the worker.

In the resin composition of the present invention, the polyolefin resin (D) is a resin that satisfies the formula (1) below:

30>X×Y÷(1−Z)≥1 (1)
where, in the formula (1), X represents the MFR (g/10 min) of the polyolefin resin (D) at 190° C., Y represents the relaxation time (seconds) of the polyolefin resin (D) at 220° C., and Z represents the density (g/cm³) of the polyolefin resin (D). The relaxation time is correlated with the time taken for the stress in the resin to be released and, specifically, can be measured using a method described later in the section of Examples.

In the present invention, the left side P (i.e., X×Y÷(1−Z), hereinafter also referred to as “characteristic value P of the polyolefin resin (D)”) of the formula (1) above is preferably 1 or more (as in the formula (1) above), more preferably 3 or more, and even more preferably 5 or more. In addition, the characteristic value P of the polyolefin resin (D) is preferably less than 30, more preferably 20 or less, and even more preferably 10 or less. When the characteristic value P of the polyolefin resin (D) satisfies the range described above, the viscosity related to the purging ability of the resin composition and the factors, namely density and relaxation time, related to the substitutability for the resin to be purged can be simultaneously satisfied, and both can be effectively improved. The higher the viscosity of the polyolefin resin (D), the more dominant the physically discharging of a degradation product during purging, but the lower the substitutability. In order to improve the substitutability of the polyolefin resin (D), metal release properties are important. Specifically, metal release properties are improved by increasing the density, which is correlated with the elastic modulus of the polyolefin resin (D), and increasing the relaxation time, and, as a result, the substitutability is improved. In the present invention, the characteristic value P is defined to fall within a range in which those factors are well balanced.

The polyolefin resin (D) may be, for example, the same resin as the resin to be purged, a resin that is compatible with the resin to be purged, or a combination of both. Specific examples of the polyolefin resin (D) include polyethylene (including, for example, high-density polyethylene (HDPE), low-density polyethylene (LDPE), and linear low-density polyethylene (LLDPE)), polypropylene, EVAs (ethylene-vinyl acetate copolymers), EMMAs (ethylene-methyl methacrylate copolymers), and combinations thereof. Polyethylene, polypropylene, and combinations thereof are preferable as the polyolefin resin (D) because they are very versatile and enable the resulting resin composition to exhibit excellent purging ability when used as a purging agent.

The content of the polyolefin resin (D) is preferably 100 parts by mass or more, more preferably 200 parts by mass or more, and even more preferably 300 parts by mass or more, with respect to 100 parts by mass of the hydrophilic resin (A). In addition, the content of the polyolefin resin (D) is preferably 5000 parts by mass or less, more preferably 4000 parts by mass or less, and even more preferably 3000 parts by mass or less, with respect to 100 parts by mass of the hydrophilic resin (A). When the content of the polyolefin resin (D) is in the range described above, the compatibility between the resin composition of the present invention and the resin to be purged in the molding machine is improved, the efficiency of discharging the resin to be purged in the molding machine is enhanced even further, and the safety of the worker can also be improved.

### Additional Additive

The resin composition of the present invention may contain an additional additive to the extent that the effects of the present invention are not inhibited. Examples of the additional additive include an abrasive, a filler, a thermal stabilizer, a processing aid, an antiblocking agent, an antistatic agent, a coupling agent, an antioxidant, a lubricating agent, a foaming agent, a surfactant, a plasticizer, and combinations thereof. In particular, the abrasive is used to discharge the resin to be purged in the molding machine through a physical abrasive action, and examples include those composed of an inorganic compound such as alumina, zirconia, silica, titanium dioxide, or calcium carbonate.

The content of the additional additive in the resin composition of the present invention is not particularly limited, and can be appropriately set by a person skilled in the art to the extent that the purging efficiency of a combination of the above-described hydrophilic resin (A), water (B), basic compound (C), and polyolefin resin (D) is not impaired.

### Additional Component

The resin composition of the present invention preferably contains at least one element selected from the group consisting of silicon and phosphorus. The content of the at least one element is preferably 10 ppm or more, more preferably 30 ppm or more, and even more preferably 50 ppm or more, with respect to the resulting resin composition. With regard to the content of the at least one element, the content of silicon and phosphorus is preferably 1000 ppm or less, more preferably 500 ppm or less, and even more preferably 250 ppm or less, with respect to the resulting resin composition. Elements such as silicon and phosphorus can be contained, for example, as part of an additive in the polyolefin resin (D). In the present invention, the addition of the at least one element in the range described above reduces the friction between resins in the hopper when the resulting resin composition is used as a purging agent, thereby enabling a sufficient discharge volume to be ensured, and the thus increased discharge volume can maintain the shearing stress and high purging ability.

### Divalent Metal Element

It is preferable that contamination of the resin composition of the present invention with a divalent metal element is suppressed. Examples of the divalent metal element include calcium, magnesium, and a combination thereof.

A divalent metal element can be present in a resin composition in the form of a divalent metal salt, for example. However, if a resin composition containing a divalent metal element is used as a purging agent, sufficient purging ability may not be exhibited. Specifically, the reason for this is that the divalent metal element may inhibit the basicity of potassium ions in the resin composition through salt exchange with the potassium ions.

Therefore, in the resin composition of the present invention, the content of the divalent metal element is adjusted to preferably 100 ppm or less (i.e., 0 to 100 ppm), more preferably 70 ppm or less (i.e., 0 to 70 ppm), and most preferably 50 ppm or less (i.e., 0 to 50 ppm), with respect to the resulting resin composition.

The resin composition of the present invention is preferably in pellet form because it is suitable for use as a purging element.

### Purging Agent

A purging agent of the present invention is, in the first embodiment, composed of the above-described resin composition, or in other words, a resin composition containing a hydrophilic resin (A), water (B), a basic compound (C), a polyolefin resin (D), and an additional additive, which is an optional component. In the present specification, the purging agent composed of the above-described resin composition is referred to as a “first purging agent”.

In addition, the purging agent of the present invention is, in the second embodiment, composed of the above-described resin composition excluding water (B), or in other words, a resin composition containing a hydrophilic resin (A), a basic compound (C), a polyolefin resin (D), and an additional additive, which is an optional component. In the present specification, the purging agent composed of the above-described resin composition excluding water (B) is referred to as a “second purging agent”.

As for the types and contents of the hydrophilic resin (A), the basic compound (C), the polyolefin resin (D), and the additional additive in the second purging agent of the present invention, types and contents that are similar to the types and contents of those contained in the first purging agent can be selected. Furthermore, the ethylene unit content and saponification degree of the hydrophilic resin (A) contained in the second purging agent of the present invention can be set to be similar to those of the hydrophilic resin (A) contained in the first purging agent as well.

The first purging agent of the present invention has excellent safety, because the worker does not need to adjust the contents of the components of the purging agent when loading the purging agent into the molding machine. On the other hand, the second purging agent of the present invention can improve the efficiency in transporting and storing the purging agent, because the second purging agent does not contain water (B) in advance, and the total mass and volume of the purging agent can be reduced as compared with those of the first purging agent.

In the present invention, the first purging agent can be directly loaded into the molding machine in which the resin to be purged is present, through a hopper, for example, and used.

On the other hand, in the case of the second purging agent of the present invention, a predetermined amount of water (B) is added to the second purging agent before use, to prepare a resin composition of the present invention, and the prepared composition can be loaded into the molding machine in which the resin to be purged is present, through the hopper, for example, and used. Alternatively, in the case of the second purging agent of the present invention, it is also possible that the second purging agent without water (B) is loaded into the molding machine in which the resin to be purged is present, through the hopper, for example, and kneaded in a cylinder, with water (B) added through a portion (e.g., an orifice penetrating the cylinder) separately provided in the molding machine, and a resin composition of the present invention thus prepared is used.

Examples of molding machines in which the first purging agent and the second purging agent of the present invention can be used include extruders (encompassing, for example, single-screw extruders, twin-screw extruders, and the like), injection molding machines, blow molding machines, and the like.

Method for Purging Molding Machine in which Resin to be Purged is Present

In a purging method of the present invention, for example, a resin composition containing the above-described hydrophilic resin (A), water (B), and basic compound (C), polyolefin resin (D), and an additional additive, which is an optional component, is supplied into a molding machine, and the resin composition is discharged together with a resin to be purged. In the present specification, the purging method that is performed using the resin composition in this manner is referred to as a “first purging method”.

In the first purging method of the present invention, the resin composition may be supplied into the molding machine, for example, by separately supplying the above-described hydrophilic resin (A), water (B), basic compound (C), and polyolefin resin (D), and an additional additive, which is an optional component, into the molding machine through a hopper and/or other portions (e.g., an orifice penetrating a cylinder) of the molding machine, but preferably the resin composition is supplied into the molding machine in the form of the first or second purging agent of the present invention.

As an embodiment, a case where the molding machine is an extruder will be described below. When the resin composition is to be supplied into the extruder in the form of the first purging agent of the present invention, the first purging agent of the present invention is directly loaded into the extruder through the hopper thereof, for example, and then, rotation of a screw in a cylinder causes the first purging agent to be supplied into the cylinder.

When the resin composition is to be supplied into the extruder in the form of the second purging agent of the present invention, a predetermined amount of water (B) is added to the second purging agent of the present invention before use, the resulting composition is loaded into the extruder through the hopper, for example, and then, rotation of the screw in the cylinder causes the resin composition containing the second purging agent to be supplied into the cylinder. In this case, in order to prevent corrosion of metal portions such as the hopper, it is preferable to use a compound other than alkali metal hydroxides described above as the basic compound (C) constituting the second purging agent.

Alternatively, the second purging agent of the present invention is loaded into the extruder through the hopper, for example, in a state in which the second purging agent does not contain water (B), and then kneaded by rotating the screw in the cylinder, with water (B) added through a portion (e.g., an orifice penetrating the cylinder) separately provided in the molding machine. In this manner, the resin composition is supplied.

When supplying the resin composition into the molding machine, the purging temperature in the molding machine (i.e., the temperature of a melting zone of the molding machine) is preferably set to 105° C. to 170° C., and more preferably 110° C. to 160° C. If this temperature is lower than 105° C., the resin composition in the molding machine may not sufficiently melt, making it difficult to efficiently discharge the resin to be purged. If this temperature is higher than 170° C., the purging efficiency may be significantly reduced due to a decrease in the viscosity of the resin.

The amount of the resin composition supplied into the molding machine corresponds to, for example, preferably from 1 to 1000 times, and more preferably from 2 to 100 times, the volume of the resin to be purged that remains in the molding machine (for example, when the molding machine is an extruder, this volume corresponds to the volume obtained by subtracting the volume of a screw from the volume of a cylinder). If the amount of the resin composition supplied is less than one times the volume of the resin to be purged remaining in the molding machine, there is a risk of the resin to be purged being left behind in the molding machine. If the amount of the resin composition supplied is more than 1000 times the volume of the resin to be purged remaining in the molding machine, there is a risk of the resin composition being excessively supplied after the purging effect in the molding machine has already been sufficiently achieved, resulting in a decrease in the efficiency of utilization of the purging agent.

Alternatively, instead of the first purging method, the purging method of the present invention may also be performed in such a manner that an aqueous alkaline solution containing water (B) and the basic compound (C) is supplied into the molding machine, and the aqueous alkaline solution is then discharged with the resin to be purged. In the present specification, the purging method that is performed using the aqueous alkaline solution in this manner is referred to as a “second purging method”.

Water (B) used in the second purging method of the present invention is the same as that used in the resin composition of the present invention.

The basic compound (C) used in the second purging method of the present invention contains an alkali metal such as lithium, sodium, or potassium. Examples of the salt that can constitute the basic compound (C) include carbonates, bicarbonates, and phosphates.

Examples of the basic compound (C) include sodium carbonate, potassium carbonate, lithium carbonate, sodium hydrogencarbonate, potassium hydrogencarbonate, trisodium phosphate, disodium hydrogen phosphate, monosodium dihydrogen phosphate, tripotassium phosphate, dipotassium hydrogen phosphate, monopotassium dihydrogen phosphate, trilithium phosphate, dilithium hydrogen phosphate, monolithium dihydrogen phosphate, sodium acetate, potassium acetate, lithium acetate, and combinations thereof. Sodium carbonate and potassium carbonate are preferable from the viewpoint of ensuring the safety of the worker.

The pH of the aqueous alkaline solution supplied into the molding machine is preferably 8 to 14, and more preferably 10 to 13. If the pH is less than 8, the efficiency with which the resulting aqueous alkaline solution discharges the resin to be purged in the molding machine tends to be low.

In the second purging method of the present invention, the aqueous alkaline solution may be supplied into the molding machine using, for example, a method in which water (B) and the basic compound (C) are mixed in advance to prepare an aqueous alkaline solution, and the prepared aqueous alkaline solution is then supplied into the molding machine through a hopper and/or other portions (e.g., an orifice penetrating a cylinder) of the molding machine. However, an aqueous alkaline solution using a hydroxide as the basic compound (C) may cause undesired corrosion if it adheres to a metal portion such as the hopper. For this reason, it is preferable to use the fluidity of the aqueous alkaline solution to introduce the aqueous alkaline solution into the cylinder through a tube made of a chemical-resistant material (e.g., silicone rubber, Teflon (registered trademark), or the like) while thereby reducing the chance of the aqueous alkaline solution coming into contact with a metal portion other than the interior of the molding machine. Alternatively, the aqueous alkaline solution may be supplied by separately introducing water (B) and the basic compound (C) through the hopper and/or other portions (e.g., an orifice penetrating the cylinder) of the molding machine and preparing an aqueous alkaline solution in the molding machine.

When supplying the aqueous alkaline solution into the molding machine, the temperature in the molding machine (i.e., the temperature of the melting zone of the molding machine) is preferably set to 100° C. to 180° C., and more preferably 105° C. to 170° C. If this temperature is lower than 100° C., it may be difficult to efficiently discharge the resin to be purged. If this temperature is higher than 180° C., there is a risk of some of the water evaporating, making the aqueous alkaline solution unable to efficiently react with the resin to be purged.

When the aqueous alkaline solution is supplied according to the second purging method of the present invention, the interior of the molding machine may be subsequently washed with an appropriate amount of water (e.g., pure water, ion-exchanged water, distilled water, tap water, or a combination thereof) in order to prevent corrosion in the molding machine.

According to the present invention, various resins to be purged can be purged. In particular, according to the present invention, a resin to be purged that has a MFR (melt flow rate; g/10 min) at 190° C., for example, similar to or higher than the MFR at 190° C. of the polyolefin resin (D) can be effectively purged.

This resin to be purged may be, for example, a thermoplastic resin or a mixture (molding resin composition) containing the thermoplastic resin. Examples of the thermoplastic resin constituting the resin to be purged include EVOHs; polyolefin resins such as polyethylene (including, for example, high-density polyethylene (HDPE) and low-density polyethylene (LDPE)) and polypropylene; polyester resins such as polyethylene terephthalate (PET), polyethylene-2,6-naphthalate, polybutylene terephthalate, and copolymers thereof, polyamide resins such as nylon-6, nylon-66, and nylon-12; hydroxyl-containing polymers such as polyvinyl alcohol; polystyrene; poly(meth)acrylic acid esters; polyacrylonitrile; polyvinyl acetate; polycarbonate; polyallylate; regenerated cellulose; polyimide; polyetherimide; polysulfone; polyethersulfone; polyether ether ketone; ionomer resins; and the like.

The purging method of the present invention can be used for purging of molding machines in which various resins to be purged are used. In particular, the purging method of the present invention is useful in purging of not only blow molding machines but also inflation molding machines and cast molding machines for molding general packaging materials, because it can exhibit excellent purging ability even for relatively low-viscosity resins to be purged.

### EXAMPLES

Hereinafter, the present invention will be described in detail using examples, but the present invention is not limited to these examples.

### (1) Method for Measuring Median Pore Diameter

EVOH pellets used in examples and comparative examples were frozen at −80° C. and then freeze-dried, to prepare pore measurement samples. About 0.5 g of each measurement sample was taken into a standard 5-cc powder cell (stem volume: 0.4 cc) and subjected to measurement using a Micromeritics pore distribution measuring apparatus (AutoPore V 9620 available from Shimadzu Corporation) under the condition of an initial pressure of 2.6 kPa. As mercury parameters, the mercury contact angle was set to 130°, and the mercury surface tension was set to 485 dynes/cm, and calculation was performed within a pore diameter range of 0.005 to 100 μm.

### (2) Method for Measuring Average Particle Size

100 g of each of the freeze-dried pore measurement samples was subjected to dynamic image analysis in conformity with ISO 13322-2 (2006) using “CAMSIZER XT” from Verder Scientific, and the particle size (Q3 50.0%) at 50% (on a volume basis) from the small particle size side in a cumulative particle size distribution of the calculated equivalent circle diameters of particles was determined as an average particle size (mm).

### (3) Content of Basic Compound (C)

0.5 g each of the EVOH pellets used in the examples and the comparative examples was placed in a pressure vessel made of Teflon (registered trademark), to which was added 5 mL of concentrated nitric acid, and then allowed to decompose at room temperature for 30 minutes. After 30 minutes, the pressure vessel was covered, and the pellets were decomposed through heating at 150° C. for 10 minutes and then at 180° C. for 5 minutes using a wet decomposition apparatus (MWS-2 available from ACTAC Co., Ltd.) and subsequently cooled to room temperature. This treated solution was transferred to a 50-mL volumetric flask (made of TPX) and diluted with pure water. Metals contained in this solution were analyzed using an ICP emission spectrometer (“OPTIMA 4300 DV” available from PerkinElmer), and the potassium element content was determined. Based on the obtained potassium element content, a value converted from the molecular weight of a carbonate containing that element was obtained.

### (4) Calculation of Characteristic Value P of Polyolefin Resin (D) Used

Polyolefin resins (D) used in the examples and the comparative examples were subjected to measurement using a melt flow indexer in conformity with JIS K7210:2014, and the MFR (X) (g/cm³) of each polyolefin resin (D) at 190° C. and 2160 g was determined. On the other hand, with respect to the polyolefin resins (D) used in the examples and the comparative examples, the relaxation time (Y) (seconds) of each polyolefin resin (D) at 220° C. was determined by dividing the storage modulus by the loss modulus at an angular frequency of 1 rad/s derived from frequency-dependent measurement at a strain of 1% using ARES-G2 available from TA Instruments Japan Inc. With use of the thus obtained X value and Y value, as well as the density (Z) (g/cm³; catalog value) of the polyolefin resin (D) used, the characteristic value P of that polyolefin resin (D) was calculated using the following equation:

$$P = X \times Y \div ( 1 - Z )$$

### (5) Contents of Silicon (Si), Phosphorus (P), and Divalent Metal

The amounts of silicon (Si), phosphorus (P), and a divalent metal contained in each of the polyolefin resins (D) used in the examples and the comparative examples were measured using an X-ray fluorescence spectrometer (ZSX Primus-μ available from Rigaku Corporation). Based on the obtained measurement results, the proportions of silicon (Si), phosphorus (P), and the divalent metal element in the resin composition were calculated.

### (6) Evaluation of Purging Ability (Substitutability)

A single-screw extruder (available from Toyo Seiki Seisaku-sho, Ltd.; 20 mm φ) and a coat-hanger die were used, and each of resin compositions (with a MFR at 190° C. of 1.6 g/10 min) obtained in the examples and the comparative examples was run at an extrusion temperature of 190° C. and 100 rpm for 15 minutes. Then, an EVOH (“EVAL F101” available from Kuraray Co., Ltd.) was run at 100 rpm for 30 minutes, and a film was taken off at a take-off speed of 2 m/min. The appearance of the film was evaluated, to thereby evaluate the substitutability as a result of consultation among three experts according to the following criteria. The film was cut to A4 size, and the appearance thereof was evaluated. Note that a “streak” refers to a defect that is a continuous line with a width of 1 mm extending in the MD direction, and a “hard spot” refers to a defect with a diameter of 1 mm or more. A film that falls under any of the following criteria A to C can be considered as being capable of withstanding actual use.
A: The film has 0 to 10 defects (streaks, hard spots).
B: The film has 11 to 30 or more defects (streaks, hard spots).
C: The film has 31 to 100 defects (streaks, hard spots).
D: The film has 101 defects (streaks, hard spots).

### (7) Measurement of Purging Ability (Amount of Residual Burnt Deposit)

An EVOH (“EVAL F101” available from Kuraray Co., Ltd.) serving as a resin to be purged (1) was run through a twin-screw extruder (2D25W available from Toyo Seiki Seisaku-sho, Ltd.; L/D=25) for 10 minutes, and the resin to be purged was left behind in the extruder. After stopping the rotation of the screws and allowing the resin to stay in the molding machine for 30 minutes, high-density polyethylene (“HI-ZEX 7000F” available from Prime Polymer Co., Ltd.) was run through the molding machine for 5 minutes, and the die was removed. After that, the cylinder was heated to 290° C. and then heated for 3 hours at a screw rotational speed of 10 rpm while air was introduced, to cause oxidation degradation of the resin to be purged.

Next, each of the resin compositions obtained in the examples and the comparative examples, which was used as a purging agent, was supplied through a hopper of this extruder at a purging temperature of 190° C. and a screw rotational speed of 100 rpm with an extrusion rate of 3.2 (kg/hour) for 40 minutes, then, low-density polyethylene (LC-600A available from Japan Polyethylene Corporation) was run for 3 minutes, and subsequently, low-density polyethylene (LC-600A available from Japan Polyethylene Corporation) was run for 10 minutes while the cylinder was heated to 220° C. After that, high-density polyethylene (“HI-ZEX 7000F” available from Prime Polymer Co., Ltd.) was run for 5 minutes, and then, the die was disassembled, the twin screws were removed, and the resin to be purged adhering to the screws was collected using a copper spatula. The total mass of the collected resin to be purged was measured. When the total mass of the collected resin to be purged (the amount of residual burnt deposit) was less than 3.0 g, the purging agent used can be considered as being capable of exhibiting more favorable purging ability.

### Example 1: Production of Resin Composition (JE1)

An EVOH solution containing 100 parts by mass of an EVOH (hydrophilic resin (A)) with an ethylene unit content of 32 mol % and a saponification degree of 99.98 mol %, 60 parts by mass of methanol, and 40 parts by mass of water was continuously supplied from the top tray of a tray column with 10 trays and a column diameter of 0.3 m. Water vapor was introduced through the bottom tray to bring the EVOH solution and the water vapor into countercurrent contact. The temperature in the column was 130° C., and the pressure in the column was 0.3 MPa. Water-containing EVOH pellets obtained by countercurrent contact with water vapor were extracted from the bottom of the column. The obtained water-containing EVOH pellets were supplied into a twin-screw extruder at a rate of 42 kg/hour and extruded, under the following conditions, through a die attached to a leading end of the extruder and having 8 holes with a hole diameter of 30 mm, and the melt was cut by a hot cutter with two blades at a distance of 0.05 mm from the die, and thus, water-containing EVOH pellets having flat spherical shape were obtained.

### <Conditions of Twin-Screw Extruder>

L/D: 14
Hole diameter: 30 mm
Screws: Full flight
Number of rotations: 300 rpm
Cylinder temperature: 90° C.
Die temperature: 120° C.
Number of die holes: 8

Then, 3 kg of the obtained water-containing EVOH pellets was washed in ion-exchanged water (bath ratio: 20) at 50° C. for 1 hour under stirring and deliquored. This operation was repeated twice. Subsequently, the washed water-containing EVOH pellets were placed in a 1 g/L aqueous acetic acid solution (bath ratio: 20) at 25° C. for 2 hours under stirring and deliquored. This operation was repeated twice. Furthermore, the washed water-containing EVOH pellets were placed in ion-exchanged water (bath ratio: 20) at 25° C. for 2 hours under stirring and deliquored. This operation was repeated twice. Then, the electrical conductivity of the washing solution was measured using an electrical conductivity meter “CM-30ET” available from TOA Electronics Ltd. Since the electrical conductivity of the washing solution was 10 μS/cm, a third washing was performed in a similar manner. The electrical conductivity of the washing solution after the third washing was measured and found to be 3 μS/cm, and therefore washing was stopped.

The washed water-containing EVOH pellets were immersed in a 1 mol/L aqueous potassium carbonate solution prepared using water (B) and potassium carbonate as the basic compound (C), and chemically treated for 2 hours under periodic stirring. The thus treated water-containing EVOH pellets were deliquored and dried at 60° C. for 5 hours under reduced pressure, to thereby obtain porous particles having a water content of 24 mass %. The obtained water-containing porous particles were mixed with 2500 parts by mass of high-density polyethylene (HDPE) (“NOVATEC (registered trademark) HY540” available from Japan Polyethylene Corporation) serving as the polyolefin resin (D) through dry blending, to obtain a resin composition (JE1). The purging ability of this resin composition (JE1) was evaluated as described above. Table 1 shows the results.

### Example 2: Production of Resin Composition (JE2)

A resin composition (JE2) was obtained in the same manner as in Example 1, except that 2500 parts by mass of low-density polyethylene (LDPE) (“NOVATEC (registered trademark) LJ400” available from Japan Polyethylene Corporation) was used as the polyolefin resin (D) instead of the HDPE, and the purging ability of the resin composition (JE2) was evaluated as described above. Table 1 shows the results.

### Example 3: Production of Resin Composition (JE3)

A resin composition (JE3) was obtained in the same manner as in Example 1, except that 2500 parts by mass of LDPE (“NOVATEC (registered trademark) LF342” available from Japan Polyethylene Corporation) was used as the polyolefin resin (D) instead of the HDPE, and the purging ability of the resin composition (JE3) was evaluated as described above. Table 1 shows the results.

### Example 4: Production of Resin Composition (JE4)

A resin composition (JE4) was obtained in the same manner as in Example 1, except that 2500 parts by mass of a linear low-density polyolefin resin (LLDPE) (“NOVATEC (registered trademark) UF230” available from Japan Polyethylene Corporation) was used as the polyolefin resin (D) instead of the HDPE, and the purging ability of the resin composition (JE4) was evaluated as described above. Table 1 shows the results.

### Example 5: Production of Resin Composition (JE5)

A resin composition (JE5) was obtained in the same manner as in Example 1, except that 2500 parts by mass of LDPE (“NOVATEC (registered trademark) LF128” available from Japan Polyethylene Corporation) was used as the polyolefin resin (D) instead of the HDPE, and the purging ability of the resin composition (JE5) was evaluated as described above. Table 1 shows the results.

### Example 6: Production of Resin Composition (JE6)

An EVOH solution at 60° C., the solution containing 100 parts by mass of an EVOH (hydrophilic resin (A)) with an ethylene unit content of 32 mol % and a saponification degree of 99.98 mol %, 60 parts by mass of methanol, and 40 parts by mass of water, was extruded in a strand-like shape through a metal plate having a circular opening with a diameter of 3.5 mm into a mixed solution of water and methanol (mass ratio: water/methanol=9/1) maintained at 5° C., and precipitated and solidified, and then, the strands were cut with a cutter, to obtain EVOH pellets. The EVOH pellets were placed in warm water at 30° C. and stirred for 4 hours, and thus, water-containing EVOH pellets were obtained.

Subsequently, the water-containing EVOH pellets were subjected to washing and predetermined chemical treatment in the same manner as in Example 1, and thus, porous particles were obtained.

A resin composition (JE6) was obtained in the same manner as in Example 1, except that the thus obtained porous particles were used instead of the porous particles used in Example 1, and the purging ability of the resin composition (JE6) was evaluated as described above. Table 1 shows the results.

### Example 7: Production of Resin Composition (JE7)

The evaluation was performed in the same manner as in Example 1, except that a resin composition (JE7) was obtained by mixing the water-containing porous particles obtained in Example 1 with 4268 parts by mass of high-density polyethylene (HDPE) (“NOVATEC (registered trademark) HY540” available from Japan Polyethylene Corporation) serving as the polyolefin resin (D) and potassium stearate through dry blending. Table 1 shows the results.

### Example 8: Production of Resin Composition (JE8)

The evaluation was performed in the same manner as in Example 1, except that a resin composition (JE8) was obtained by mixing the water-containing porous particles obtained in Example 1 with 2500 parts by mass of high-density polyethylene (HDPE) (“NOVATEC (registered trademark) HY540” available from Japan Polyethylene Corporation) serving as the polyolefin resin (D) and calcium stearate through dry blending. The amount of calcium stearate added was adjusted so that the calcium content including calcium contained in NOVATEC HY540 was 80 ppm. Table 1 shows the results.

### Comparative Example 1: Production of Resin Composition (JC1)

A resin composition (JC4) was obtained in the same manner as in Example 1, except that 2500 parts by mass of HDPE (“NOVATEC (registered trademark) HB111R” available from Japan Polyethylene Corporation) was used as the polyolefin resin (D) instead of the HDPE used in Example 1. Note that the characteristic value P of the polyolefin resin (D) used in this comparative example was 0.5. The purging ability of this resin composition (JC1) was evaluated as described above. Table 1 shows the results.

### Comparative Example 2: Production of Resin Composition (JC2)

A resin composition (JC2) was obtained in the same manner as in Example 1, except that 2500 parts by mass of LDPE (“NOVATEC (registered trademark) LC600” available from Japan Polyethylene Corporation) was used as the polyolefin resin (D) instead of the HDPE. Note that the characteristic value P of the polyolefin resin (D) used in this comparative example was 31.8. The purging ability of this resin composition (JC2) was evaluated as described above. Table 1 shows the results.

### Comparative Example 3: Production of Resin Composition (JC3)

As the hydrophilic resin (A), “EVAL (registered trademark) H171” available from Kuraray Co., Ltd. (an EVOH with an ethylene unit content of 38 mol %, a saponification degree of 99.9 mol %, a median pore diameter of 0.005 μm, and an average particle size of 3.5 mm) was used instead of the washed EVOH in Example 1. Chemical treatment was performed for 2 hours under periodic stirring. Water-containing EVOH pellets after the treatment were deliquored and dried at 60° C. for 5 hours under reduced pressure, to thereby obtain porous particles having a water content of 5 mass %. Otherwise, the same procedure as in Example 1 was performed, and thus, a resin composition (JC3) was obtained. The purging ability of the obtained resin composition (JC3) was evaluated as described above. Table 1 shows the results.

### Comparative Example 4: Production of Resin Composition (JC4)

A resin composition (JC4) was obtained in the same manner as in Example 1, except that 2500 parts by mass of high-density polyethylene (“HI-ZEX 7000F” available from Prime Polymer Co., Ltd.) was used as the polyolefin resin (D). Note that the characteristic value P of the polyolefin resin (D) used in this comparative example was 0.7. The purging ability of the obtained resin composition (JC4) was evaluated as described above. Table 1 shows the results.

TABLE 1

| | | | | Examle 1 | Examle 2 | Examle 3 | Examle 4 | Examle 5 |
|---|---|---|---|---|---|---|---|---|
| Resin | Name of Resin Composition | | | JE1 | JE2 | JE3 | JE4 | JE5 |
| Composition | Hydrophilic Resin (A) | Type | — | EVOH | EVOH | EVOH | EVOH | EVOH |
| | | Content | Parts by Mass | 100 | 100 | 100 | 100 | 100 |
| | | Median Pore Diameter | μm | 0.11 | 0.11 | 0.11 | 0.11 | 0.11 |
| | | Average Particle Size | mm | 3.2 | 3.2 | 3.2 | 3.2 | 3.2 |
| | Water (B) | Content | Parts by Mass | 25 | 25 | 25 | 25 | 25 |
| | Basic Compund (C) | Type | — | K₂CO₃ | K₂CO₃ | K₂CO₃ | K₂CO₃ | K₂CO₃ |
| | | Content | Parts by Mass | 7 | 7 | 7 | 7 | 7 |
| | Polyolefin Resin (D) | Type | — | HDPE | LDPE | LDPE | LLDPE | LDPE |
| | | Content | Parts by Mass | 2500 | 2500 | 2500 | 2500 | 2500 |
| | | Brand | — | HY540 | LJ400 | LF342 | UF230 | LF128 |
| | | Density (Z) | g/cm³ | 0.96 | 0.921 | 0.924 | 0.921 | 0.922 |
| | | MFR@190° C., 2.16 kg (X) | g/10 min. | 1 | 1.5 | 1 | 1 | 0.25 |
| | | Relaxation Time@220° C. (Y) | Seconds | 0.20 | 0.36 | 0.48 | 0.17 | 0.82 |
| | | X × Y/(1 − Z) | — | 5.1 | 6.8 | 6.4 | 2.1 | 2.6 |
| | Si | Content | ppm | 100 | 40 | 20 | 120 | 10 |
| | P | Content | ppm | 80 | 30 | 30 | 70 | 10 |
| | Divalent Metal | Type | — | Ca | Ca | Ca | Ca | Ca |
| | | Content | ppm | 40 | 40 | 70 | 30 | 50 |
| | Mixing Ratio | ((A) + (B) + (C))/(D) | — | 5/95 | 5/95 | 5/95 | 5/95 | 5/95 |
| Evaluation | Purging Ability | Substitutability | — | A | B | B | C | C |
| | | Amount of Residual | g | 1.1 | 0.9 | 1.3 | 1.2 | 1.0 |
| | | Burnt Deposit | | | | | | |

| | | | | | | | Comparative |
|---|---|---|---|---|---|---|---|
| | | | | Examle 6 | Examle 7 | Examle 8 | Example 1 |
| Resin | Name of Resin Composition | | | JE6 | JE7 | JE8 | JC1 |
| Composition | Hydrophilic Resin (A) | Type | — | EVOH | EVOH | EVOH | EVOH |
| | | Content | Parts by Mass | 100 | 100 | 100 | 100 |
| | | Median Pore Diameter | μm | 4 | 0.11 | 0.11 | 0.11 |
| | | Average Particle Size | mm | 4.2 | 3.2 | 3.2 | 3.2 |
| | Water (B) | Content | Parts by Mass | 25 | 25 | 25 | 25 |
| | Basic Compund (C) | Type | — | K₂CO₃ | K₂CO₃ | K₂CO₃ | K₂CO₃ |
| | | Content | Parts by Mass | 1 | 7 | 7 | 7 |
| | Polyolefin Resin (D) | Type | — | HDPE | HDPE | HDPE | HDPE |
| | | Content | Parts by Mass | 2394 | 4268 | 2500 | 2500 |
| | | Brand | — | HY540 | HY540 | HY540 | HB111R |
| | | Density (Z) | g/cm³ | 0.96 | 0.96 | 0.96 | 0.945 |
| | | MFR@190° C., 2.16 kg (X) | g/10 min. | 1 | 1 | 1 | 0.03 |
| | | Relaxation Time@220° C. (Y) | Seconds | 0.20 | 0.20 | 0.20 | 0.92 |
| | | X × Y/(1 − Z) | — | 5.1 | 5.1 | 5.1 | 0.5 |
| | Si | Content | ppm | 100 | 168 | 100 | 150 |
| | P | Content | ppm | 80 | 134 | 80 | 60 |
| | Divalent Metal | Type | — | Ca | Ca | Ca | Ca |
| | | Content | ppm | 20 | 67 | 80 | 0 |
| | Mixing Ratio | ((A) + (B) + (C))/(D) | — | 5/95 | 3/97 | 5/95 | 5/95 |
| Evaluation | Purging Ability | Substitutability | — | A | B | A | D |
| | | Amount of Residual | g | 2.9 | 1.9 | 1.6 | 0.8 |
| | | Burnt Deposit | | | | | |

| | | | | Comparative | Comparative | Comparative |
|---|---|---|---|---|---|---|
| | | | | Example 2 | Example 3 | Example 4 |
| Resin | Name of Resin Composition | | | JC 2 | JC 3 | JC 4 |
| Composition | Hydrophilic Resin (A) | Type | — | EVOH | EVOH | EVOH |
| | | Content | Parts by Mass | 100 | 100 | 100 |
| | | Median Pore Diameter | μm | 0.11 | 0.005 | 0.11 |
| | | Average Particle Size | mm | 3.2 | 3.5 | 3.2 |
| | Water (B) | Content | Parts by Mass | 25 | 5 | 25 |
| | Basic Compund (C) | Type | — | K₂CO₃ | K₂CO₃ | K₂CO₃ |
| | | Content | Parts by Mass | 7 | 0.05 | 7 |
| | Polyolefin Resin (D) | Type | — | LDPE | HDPE | HDPE |
| | | Content | Parts by Mass | 2500 | 2500 | 2500 |
| | | Brand | — | LC600 | HY540 | 7000F |
| | | Density (Z) | g/cm³ | 0.918 | 0.960 | 0.951 |
| | | MFR@190° C., 2.16 kg (X) | g/10 min. | 7 | 1 | 0.04 |
| | | Relaxation Time@220° C. (Y) | Seconds | 0.37 | 0.20 | 0.91 |
| | | X × Y/(1 − Z) | — | 31.8 | 5.1 | 0.7 |
| | Si | Content | ppm | 5 | 100 | 20 |
| | P | Content | ppm | 10 | 80 | 20 |
| | Divalent Metal | Type | — | Ca | Ca | Ca |
| | | Content | ppm | 60 | 30 | 140 |
| | Mixing Ratio | ((A) + (B) + (C))/(D) | — | 5/95 | 5/95 | 5/95 |
| Evaluation | Purging Ability | Substitutability | — | A | A | D |
| | | Amount of Residual | g | 3.5 | 4.1 | 2.2 |
| | | Burnt Deposit | | | | |

As shown in Table 1, all of the resin compositions (JE1) to (JE8) obtained in Examples 1 to 6 had excellent purging ability in terms of both the substitutability and the amount of residual burnt deposit. In particular, when the resin compositions (JE1) to (JE5) obtained in Examples 1 to 5 were used, the amount of the resin to be purged adhering to the screws was reduced to a very low value in the vicinity of 1 g, indicating that these resin compositions are extremely useful as purging agents. In contrast, the resin compositions (JC1), (JC2), (JC3), and (JC4) obtained in Comparative Examples 1 to 4 had good purging ability in terms of either the substitutability or the amount of residual burnt deposit, but did not show good results in terms of both the substitutability and the amount of residual burnt deposit.

### INDUSTRIAL APPLICABILITY

The present invention is useful, for example, in the field of plastic molding, in that the present invention makes it possible to reduce defects in products obtained through a molding machine and reduce the significant time and material losses required to eliminate such defects.

1. A resin composition comprising a hydrophilic resin (A), water (B), a basic compound (C), and a polyolefin resin (D),
wherein the content of the water (B) is 10 to 70 parts by mass with respect to 100 parts by mass of the hydrophilic resin (A),
the content of the basic compound (C) is 0.1 to 15 parts by mass with respect to 100 parts by mass of the hydrophilic resin (A), and
the polyolefin resin (D) satisfies the formula (1) below:
$$30 > X \times Y \div ( 1 - Z ) \geq 1 \qquad ( 1 )$$
where, in the formula (1), X represents MFR (g/10 min) of the polyolefin resin (D) at 190° C., Y represents relaxation time (seconds) of the polyolefin resin (D) at 220° C., and Z represents density (g/cm³) of the polyolefin resin (D).

2. The resin composition according to claim 1, wherein the hydrophilic resin (A), the water (B), and the basic compound (C) are contained together in the form of a water-containing hydrophilic resin.

3. The resin composition according to claim 2, wherein the water-containing hydrophilic resin is in porous particle form and has a median pore diameter of 0.01 to 3 μm and an average particle size of 2.5 to 8 mm.

4. The resin composition according to claim 1, wherein the content of the polyolefin resin (D) is 100 to 5000 parts by mass with respect to 100 parts by mass of the hydrophilic resin (A).

5. The resin composition according to claim 1, wherein the hydrophilic resin (A) is an ethylene-vinyl alcohol copolymer.

6. The resin composition according to claim 5, wherein the ethylene-vinyl alcohol copolymer has an ethylene unit content of 15 to 60 mol %.

7. The resin composition according to claim 1, wherein the basic compound (C) is at least one selected from alkali metal carbonates, alkali metal bicarbonates, alkali metal phosphates, alkali metal acetates, alkali metal hydroxides, ammonia, and primary to tertiary amines.

8. The resin composition according to claim 1, wherein the polyolefin resin (D) is at least one resin selected from the group consisting of polyethylene and polypropylene.

9. The resin composition according to claim 1, further comprising at least one element selected from the group consisting of silicon and phosphorus in a proportion of 10 to 1000 ppm.

10. The resin composition according to claim 1, further comprising a divalent metal element in a proportion of 100 ppm or less.

11. The resin composition according to claim 1, wherein the divalent metal element is at least one element selected from the group consisting of calcium and magnesium.

12. The resin composition according to claim 1, which is in pellet form.

13. A purging agent comprising the resin composition according to claim 1.

14. The purging agent according to claim 13, which is used for purging of a molding machine that uses a molding resin composition having a MFR (g/10 min) higher than half the value of that of the polyolefin resin (D) at 190° C. or melt fluidity higher than half the melt fluidity of the polyolefin resin (D).

15. The purging agent according to claim 14, which is used for purging of a food packaging material molding machine.

16. A method for purging a molding machine in which a resin to be purged is present, the method comprising supplying the purging agent according to claim 13 into the molding machine and discharging the purging agent together with the resin to be purged.
